(19) United States
(12) Patent Application Publication
(10) Pub. No.: US 2016/0222278 A1
(43) Pub. Date: Aug. 4, 2016

(54) Encapsulated Production Chemicals

(71) Applicants: Schlumberger Norge AS, Forus (NO); M-I Drilling Fluids UK Ltd., Scotland (GB); M-I L.L.C., Houston, TX (US)

(72) Inventors: Rachael Anne Cole, Sandnes (NO); Neil David Feasey, Southampton (GB); Chandrashekhar Yeshwant Khandekar, Katy, TX (US); Tore Nordvik, Sandnes (NO); Neil Grainger, Stockton-on-Tees (GB)

(21) Appl. No.: 14/932,498

(22) Filed: Nov. 4, 2015

Related U.S. Application Data
(60) Provisional application No. 62/074,684, filed on Nov. 4, 2014.

(51) Int. Cl. C09K 8/536

(52) U.S. Cl. CPC C09K 8/536

(57) ABSTRACT

A composition may include a branched polymer to encapsulate a guest molecule to be released under oilfield conditions. The guest molecule may include a production chemical, such as a scale or corrosion inhibitor. The branched polymer may be substituted with fatty acids. The branched polymer may also function as both an ecapsulator as well as a production chemical in certain applications.

### CROSS-REFERENCE TO RELATED APPLICATIONS

This application claims priority to U.S. Provisional Application No. 62/074,684 filed on Nov. 4, 2014, the entire contents of which are hereby incorporated by reference herein.

### BACKGROUND

During the production of hydrocarbons from a reservoir, chemical and physical changes may occur within the fluids from the well as they are transported from the reservoir and through a processing system. Fluids from a well may be a mixture of liquid hydrocarbons, gaseous hydrocarbons, water and various solids and chemicals. Rapid changes in temperature, pressure and agitation can create changes in the fluid characteristics that can affect the efficiency of the overall production and processing system. Problems that arises as a result of these changes to the fluid characteristics may include deposition of undesired matter in a system, for example, scales, corrosion products, paraffin wax, asphaltenes, napthenates and gas hydrates. Generally, production chemicals are required to mitigate or overcome these types of problems.

Production chemicals, as used herein, may refer to any chemical, composition, formulation, or the like, utilized to support and/or enhance the production, processing, and/or transportation of petroleum products. Generally, production chemicals may include, but are not limited to, chemicals and/or compositions to inhibit corrosion, emulsion(s), gas hydrates, scale, bacteria, foam, wax, paraffin, asphaltenes, grease build-up, heterogeneous material build-up, and/or hydrogen sulfide. Many factors must be considered in selecting the appropriate production chemical or combination of chemicals, including, but not limited to, performance, environmental restrictions, compatibility, stability and cost.

### BRIEF DESCRIPTION OF DRAWINGS

FIG. 1 shows the amount of phosphorus measured by ICP in the aqueous layer at various concentrations of scale inhibitor.

FIG. 2 shows the results of an encapsulation study of a corrosion inhibitor comprising benzalkonium chloride by PEI+palmitic acid in xylene.

FIG. 3 shows the results of release of a phosphorus-containing production chemical from a dendrimer host molecule in different brine solutions and various pH levels.

### DETAILED DESCRIPTION

The following detailed description is of the best currently contemplated modes of carrying out the various aspects of this disclosure. The description is not to be taken in a limiting sense, but is made merely for the purpose of illustrating the general principles of the disclosure, since the scope of the disclosure is best defined by the appended claims.

In the following description, numerous specific details are set forth to provide a thorough understanding of the present disclosure. However, details unnecessary to obtain a complete understanding of the present disclosure may have been omitted in as much as such details are within the skills of persons of ordinary skill in the relevant art.

Embodiments of the present disclosure relate to encapsulation of production chemicals. In other embodiments, the present disclosure relates to encapsulation means whereby the branched polymer (e.g., dendrimer) serves as both an encapsulator and production chemical, such as, for example, a pour point depressant (i.e., wax inhibitor) and/or an asphaltene dispersant. The present disclosure also provides for a composition and method for treating a fluid, and more specifically, a hydrocarbon fluid. For purposes herein, a hydrocarbon fluid refers to any fluid which comprises a hydrocarbon. Hydrocarbon fluids of the present disclosure may include crude oil, crude oil condensate, and the various streams which are produced during extraction of hydrocarbons from wells. Also included are refined streams including various fuel oils, diesel fuel, kerosene, gasoline, and the like.

Compositions and methods herein may provide a means by which to protect a chemical within a branched polymer or dendrimer that would otherwise degrade in a conventional oilfield storage means or application. Compositions and methods herein may also provide a means by which to allow targeted or delayed release of a chemical encapsulated within a branched polymer or dendrimer.

Host molecules disclosed herein may be in the form of branched (e.g., hyperbranched) polymers and may include dendrimer systems which may accommodate (e.g., encapsulate, release, etc.) guest molecules. One possible type of dendrimer may include polyester polyol dendrimers, such as shown in the formula below.

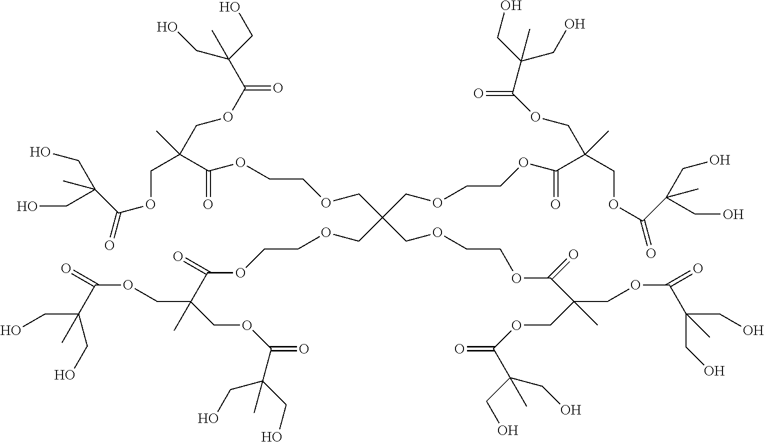 [SMILES: CC(CO)(CO)C(=O)OCC(C)(COC(=O)C(C)(CO)CO)C(=O)OCCOCC(COCCOC(=O)C(C)(COC(=O)C(C)(CO)CO)COC(=O)C(C)(CO)CO)(COCCOC(=O)C(C)(COC(=O)C(C)(CO)CO)COC(=O)C(C)(CO)CO)COCCOC(=O)C(C)(COC(=O)C(C)(CO)CO)COC(=O)C(C)(CO)CO]

The polyester polyol may be functionalized with fatty acids such as palmitic acid, stearic acid or behenic acid, by way of acid catalyzed esterification.

In other embodiments, the dendrimer used to encapsulate a guest molecule may include a polyethylenimine (PEI), such as shown in the formula below. The polyethylenimines may also have been functionalized with fatty acids such as palmitic acid, stearic acid or behenic acid via an amidation reaction. The present disclosure further contemplates other branched polymers and/or dendrimers having any suitable variation of core size and percent substitution (i.e., percent coverage) with fatty acids or functionalized with ethylene oxide polymer chains having alkyl terminations.

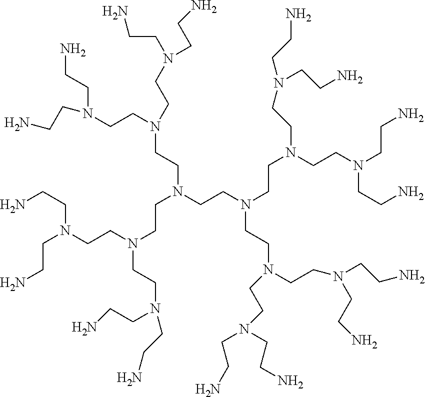 [SMILES: NCCN(CCN)CCN(CCN(CCN)CCN)CCN(CCN(CCN(CCN)CCN)CCN(CCN)CCN)CCN(CCN(CCN(CCN)CCN)CCN(CCN)CCN)CCN(CCN(CCN)CCN)CCN(CCN)CCN]

Encapsulation of Guest Molecules

Numerous dendrimers were tested for the ability to encapsulate various compositions serving as guest molecules, such as colored dyes which provided means by which transfer from aqueous to organic layer could be visually observed. The colored dyes and/or guest molecules may contain chemical components that are also typically found in production chemicals, such as sulphates, phenol groups, halogens, amines, azo groups, aromatics, carboxylates, or a combination thereof. The transfer of an aqueous soluble colored dye to an organic layer was observed. Such transfer occurred in the presence of a dendrimer, such as a hyper-branched polymer dendrimer, which encapsulated the dye as the guest molecule. Examples of dendrimer systems which encapsulated aqueous soluble dyes are shown in Table 1.

TABLE 1

| | Fatty | % | Dye | |
|---|---|---|---|---|
| Dendrimer Core | Acid | Coverage | encapsulated | Solvent |
| Polyester polyol | C16 | 75 | Bengal Rose | Chloroform/Xylene |
| 5100 MW | | | | |
| | C18 | 50 | Methyl Orange | Chloroform |
| | C22 | 50 | Bengal Rose | Chloroform |
| PEI 70,000 MW | C16 | 50 | Congo Red | Chloroform |
| | C16 | 75 | Congo Red | Chloroform |
| | C18 | 50 | Congo Red | Chloroform |
| | C18 | 75 | Congo Red | Chloroform |
| PEI 25,000 MW | C16 | 50 | Congo Red | Chloroform |
| | | | Methyl Orange | Chloroform/Xylene |
| | | | Fluorescein | Chloroform |
| | | | Acid Alizarin Violet N | Chloroform |
| | | | Cresol Red | Chloroform |
| | | | 2,7-Dichlorofluorescein | Chloroform |
| | | | Hydroxynapthol blue | Chloroform |
| | | | Chicago Sky Blue 6B | Chloroform |
| | | | Bengal Rose | Chloroform/Xylene |
| | | | Reactive Red 120 | Chloroform |
| | C18 | 50 | Congo Red | Chloroform |
| | | | Bengal Rose | Xylene |
| | C22 | 50 | Congo Red | Chloroform |
| | C16 | 25 | Congo Red | Chloroform |
| | | | Bengal Rose | Xylene |
| | C16 | 75 | Congo Red | Chloroform |
| | | | Bengal Rose | Xylene |
| | C18 | 75 | Congo Red | Chloroform |
| | C22 | 75 | Congo Red | Chloroform |
| PEI 10,000 MW | C16 | 50 | Congo Red | Chloroform |
| | C16 | 75 | Congo Red | Chloroform |
| | C18 | 50 | Congo Red | Chloroform |
| | C18 | 75 | Congo Red | Chloroform |
| PEI 5,000 MW | C16 | 50 | Congo Red | Chloroform |
| | | | Bengal Rose | Xylene |
| | C18 | 50 | Congo Red | Chloroform |
| | | | Bengal Rose | Xylene |
| | C22 | 50 | Congo Red | Chloroform |
| | | | Bengal Rose | Xylene |
| | C22 | 75 | Congo Red | Chloroform |
| PEI 2,000 MW | C18 | 50 | Bengal Rose | Xylene |
| | C22 | 50 | Congo Red | Chloroform |

Polyethylenimine may also be functionalized with ethylene oxide polymer chains having alkyl terminations and generally having the structure:

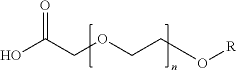

where R=alkyl chain and n=different levels of ethoxylation. The resulting molecule, herein referred to as PEI+EO, may have a molecular weight between 1000-70,000 and the structure:

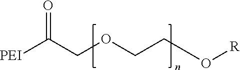

To evaluate the encapsulation properties of the PEI+EO products they were first dissolved in chloroform and then a dye solution of either Congo red, Bengal Rose and Methyl orange was added and the samples were agitated. Visual inspection of the resulting encapsulation showed nearly universal encapsulation of the dyes by the PEI+EO dissolved in chloroform, as shown in Table 2. Note that xylene may also be used as a solvent.

TABLE 2

| | | | Dye encapsulated | | |
|---|---|---|---|---|---|
| Polyethylenimine | Substituent | | Congo | Methyl | Bengal |
| Core | R | n | Red | Orange | Rose |
| 70,000 MW | C8 | 8 | Y | Y | Y |
| | C12/C14 | 2,5 | Y | Y | Y |
| | C16/C18 | 5 | Y | Y | Y |
| | C18 | 8 | Y | Y | Y |
| 25,000 MW | C8 | 8 | Y | Y | Y |
| | C12/C14 | 2 | Y | Y | Y |
| | C12/C14 | 4,5 | Y | Y | Y |
| | C12/C14 | 10 | Y | Y | Y |
| | C16/C18 | 2 | Y | Y | Y |
| | C16/C18 | 5 | Y | Y | Y |
| | C16/C18 | 9 | Y | Y | Y |
| | C18 | 8 | Y | Y | Y |
| 10,000 MW | C12/C14 | 4,5 | Y | Y | Y |
| | C12/C14 | 10 | Y | Y | Y |
| | C16/C18 | 2 | Y | Y | Y |
| | C16/C18 | 9 | Y | Y | Y |
| 5,000 MW | C8 | 8 | Y | Y | Y |
| | C16/C18 | 2 | Y | Y | Y |
| | C16/C18 | 9 | Y | Y | Y |
| | C18 | 8 | Y | Y | Y |
| 2,000 MW | C12/C14 | 2,5 | Y | Y | Y |
| | C12/C14 | 4,5 | Y | Y | Y |
| | C12/C14 | 10 | Y | Y | Y |
| | C16/C18 | 5 | Y | Y | Y |
| 1,300 MW | C8 | 8 | Y | Y | Y |
| | C12/C14 | 2,5 | Y | Y | Y |
| | C12/C14 | 10 | Y | Y | Y |
| | C16/C18 | 2 | Y | N | Y |
| | C18 | 8 | Y | Y | Y |

The process of encapsulating a production chemical is similar to that used to encapsulate dyes. Test procedure for encapsulation of production chemicals may include mixing equal volumes of a solution of a dendrimer in organic solvent (e.g., xylene or chloroform) with an aqueous soluble production chemical (e.g., scale inhibitor or corrosion inhibitor). The mixture is agitated and then allowed to separate. The aqueous layer is then tested for a decrease in the production chemical and/or the organic layer is tested for an increase in the production chemical. Ratios of production chemical vs. dendrimer may vary based on the chemical composition of the production chemical along with the characteristics of the dendrimer and solvent being used.

For production chemicals containing phosphorous, analysis can be performed on the aqueous layer by an Inductively Coupled Plasma (ICP) test. For other production chemicals that may not contain an exclusive element, analysis of both aqueous and organic layers can be performed using Liquid Chromatography-Mass Spectrometry (LC-MS) which generates a characteristic fragmentation pattern for a particular chemical made up of different molecular weight fragments. The fragmentation pattern can then be used to make a calibration curve to determine the amount of the production chemical present in either the aqueous or organic layer.

### EXAMPLE 1

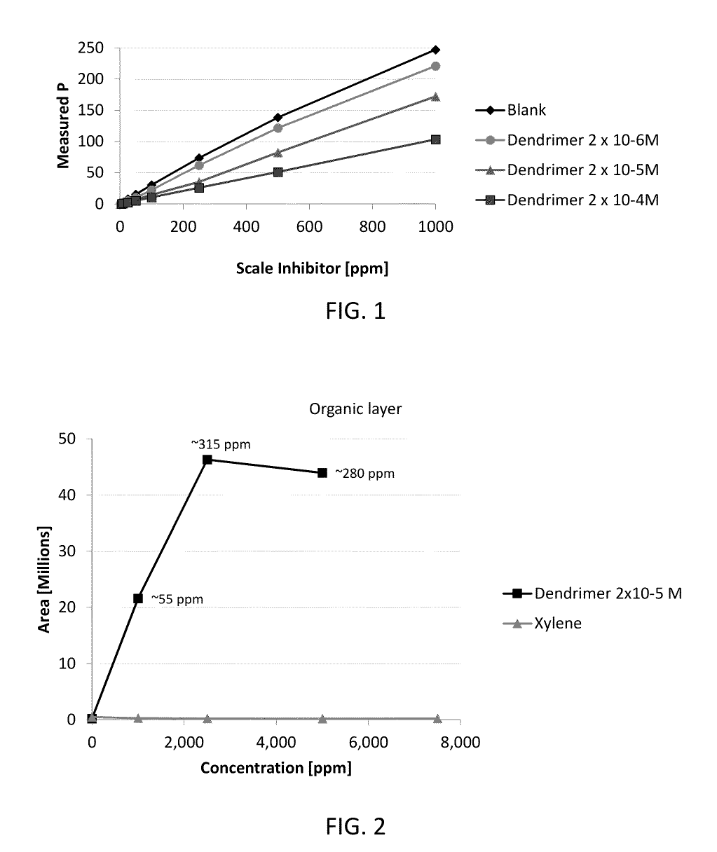

In order to evaluate encapsulation of a production chemical, four different series of tests were run at four different concentrations of dendrimer ranging 2×10⁻⁶M up to 2×10⁻⁴M and with concentrations of scale inhibitor ranging from 0 to 1000 ppm. The results are shown in FIG. 1, where the x axis shows the concentration of scale inhibitor and the y axis represents the amount of phosphorus measured by ICP in the aqueous layer. Note that the phosphorus content in the aqueous layer can only have come from the scale inhibitor as no phosphorous was present in the dendrimer or solvent.

Comparing the blank curve to the different concentrations of dendrimer, it can be seen that increasing the amount of dendrimer present in the test reduces the amount of scale inhibitor present in the aqueous layer. This is shown by a larger decrease in the slope of scale inhibitor present in each sample from 2×10⁻⁶ to 2×10⁻⁵ to 2×10⁻⁴. Thus, it appears that encapsulation of a production chemical by a dendrimer is concentration dependent and an increase in the amount of dendrimer present correlates to an increase in the amount of scale inhibitor that is encapsulated.

### EXAMPLE 2

An encapsulation study of a corrosion inhibitor comprising benzalkonium chloride by PEI+palmitic acid in xylene was carried out and evaluated utilizing LC-MS. Initial results at low concentrations showed reduction of the corrosion inhibitor in the aqueous layer, but no corresponding increase of corrosion inhibitor in the organic layer. Increasing the concentration of corrosion inhibitor used in the test shows that a threshold concentration of a corrosion inhibitor comprising benzalkonium chloride is required before the corrosion inhibitor is observed in the organic layer, as shown in FIG. 2. The corrosion inhibitor is only observed in the organic layer in the presence of the PEI dendrimer.

Release of a Guest Molecule

### EXAMPLE 3

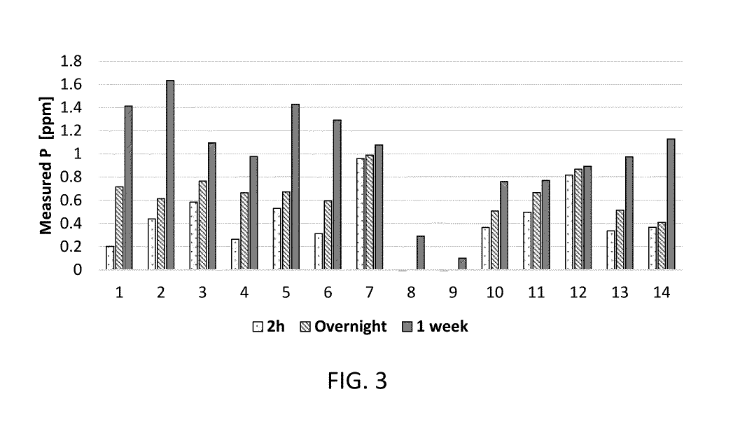

In order to be an effective means of introducing a production chemical into a production stream, the dendrimer host must be capable of releasing the guest molecule. Release of a phosphorous containing production chemical from a dendrimer host molecule was evaluated in different brine solutions and at various pH levels. A model product was prepared in xylene. The model product contained a scale inhibitor chemical encapsulated within a dendrimer. This model product was mixed with a series of different brine solutions at different pH levels all at room temperature and the brines were analyzed by ICP to determine the amount of scale inhibitor released from the model product back into the aqueous layer. The results for each brine type (1-14) after two hours, overnight and one week are shown in FIG. 3. Note that similar types of brines are grouped together (e.g., Distilled Water, 1% NaCl, 3% NaCl and an acetic acid-sodium acetate buffer system) as per Table 3 which corresponds to the test results in FIG. 3.

TABLE 3

| Test | Release Medium | pH |
|---|---|---|
| 1 | 3% NaCl | 2.39 |
| 2 | 3% NaCl | 3.36 |
| 3 | 3% NaCl | 5.31 |
| 4 | 1% NaCl | 2.48 |
| 5 | 1% NaCl | 3.54 |
| 6 | 1% NaCl | 5.42 |
| 7 | Water | 2.52 |
| 8 | Water | 4.63 |
| 9 | Water | 5.62 |
| 10 | Acetic Acid Brine | 2.78 |
| 11 | Sodium Acetate - Acetic Acid Brine | 3.13 |
| 12 | Sodium Acetate - Acetic Acid Brine | 5.03 |
| 13 | Sodium Acetate - Acetic Acid Brine | 6.60 |
| 14 | Sodium Acetate Brine | 7.86 |

In almost all cases, scale inhibitor was shown to be released to the aqueous layer and the amount of scale inhibitor released increased with time. The highest level of release shown in FIG. 2, corresponds to about 8 ppm scale inhibitor. It is also important to note, release was also shown to be tolerant of changes in pH between 2 and 8. Similar results were observed for release of an encapsulated corrosion inhibitor

Dendrimers as Production Chemicals

Some PEI dendrimers and PEI dendrimer derivatives have shown performance as production chemicals, particularly as phosphonate scale inhibitors, asphaltene dispersants and pour point depressant (i.e., wax inhibitors). As an example for illustrative purposes only, the host dendrimer molecule (e.g., encapsulator) may act as an asphaltene inhibitor while the guest molecule encapsulated by the host molecule may be a scale inhibitor which is released from the host when introduced into a production stream to inhibit the formation of scale.

### EXAMPLE 4

Table 4 shows performance data for PEIs substituted with various lengths of fatty acids as asphaltene dispersants in a crude sample in xylene, 500 ppm dosage. Performance was evaluated based on the amount of precipitate was observed in the sample after a given time period. “None” indicates that no performance from the chemical was observed (i.e., the chemical treated sample looks similar to untreated sample). “Some” indicates that moderate performance of the substituted PEIs because less precipitated asphaltenes were observed as compared to untreated sample. And “Good” indicates that no precipitated asphaltenes were observed.

TABLE 4

| Polyethylenimine | | Visually observed performance after | | | |
|---|---|---|---|---|---|
| Core | Fatty Acid | 30 mins | 2 hrs | 4 hrs | 24 hrs |
| 25,000 MW | C16 | Some | Some | None | None |
| 10,000 MW | C16 | Good | Some | Some | None |
| 10,000 MW | C16 | Good | Good | Good | Some |
| 10,000 MW | C18 | Good | Some | Some | None |
| 10,000 MW | C18 | Good | Some | Some | Some |
| 5,000 MW | C16 | Some | Some | None | None |
| 5,000 MW | C18 | Some | Some | None | None |
| 2,000 MW | C16 | Some | Some | None | None |
| 1,300 MW | C18 | Some | Some | None | None |

While fatty acid substituted PEIs having a molecular weight between 1,300-25,000 showed moderate performance in dispersing asphaltenes in a crude oil, PEIs with a molecular weight of 10,000 and substituted with a fatty acid of chain of length 16 showed the least precipitate after longer periods of exposure.

### EXAMPLE 5

The pour point of the crude oil is the lowest temperature at which movement of the crude is observed. Production challenges caused by an elevated pour point can be present when the ambient temperature is below the pour point. Typically, pour-point issues arise during periods of very low or no flow. When flow is present, pour-point related problems are usually minimized, but high viscosity at lower temperatures can still be a factor. Table 5 shows performance data for PEIs substituted with various lengths and types of fatty acids as pour point depressants in a crude sample cooled over a temperature range between 60 to −20° C. at a dosage of 500 ppm active compared to a commercially available pour point depressant product (i.e., polyalkylacrylate). Pour point was determined utilizing a rheometer.

TABLE 5

| Polyethylenimine Core | Fatty Acid | % Coverage | Pour point at 100 cP |
|---|---|---|---|
| 25,000 MW | C18 | 75 | −10.3° C. |
| 25,000 MW | C18 | 50 | −10.0° C. |
| 25,000 MW | C16 | 75 | −5.8° C. |
| 2,00 MW | C18 | 50 | −5.8° C. |
| 5,000 MW | C18 | 50 | −3.9° C. |
| 25,000 MW | C16 | 50 | −3.9° C. |
| 5,000 MW | C16 | 50 | −0.4° C. |
| 1,300 MW | C18 | 50 | −1.3° C. |
| 1,300 MW | C16 | 50 | 0.5° C. |
| 2,000 MW | C16 | 50 | 0.9° C. |
| 25,000 MW | C16 | 25 | 0.5° C. |
| Commercial Reference | — | — | −12.8° C. |

Compositions and methods herein may provide encapsulation of guest molecules (e.g., production chemicals) with controlled or slow release of such guest molecules as opposed to instant release. Also, the aforementioned may provide the ability to couple both a water soluble guest molecule and an oil soluble host molecule into one product. Further, host molecules mentioned herein showing performance as production chemicals may provide multi-functional application within a single product. Thus, the single product may be useful in oilfield applications whereby a single injection line is utilized.

A method of treating a hydrocarbon fluid may include adding an encapsulated production chemical according to any one or combination of embodiments disclosed herein to a first hydrocarbon fluid to produce a second hydrocarbon fluid. In an embodiment, the first hydrocarbon fluid is a hydrocarbon fluid produced during extraction of hydrocarbons from a well, crude oil, a crude oil condensate, a middle distillate, a fuel oil, diesel, or a combination thereof. In an embodiment, a pour point temperature of the second hydrocarbon fluid is less than a pour point temperature of the first hydrocarbon fluid. In addition, an amount of asphaltene precipitate from the first hydrocarbon fluid is higher than an amount of asphaltene precipitate from the second hydrocarbon fluid over a specific period of time. The encapsulated production chemical may be added to the first hydrocarbon fluid at a concentration between 10-1000 ppm, or more particularly at a concentration of 500 ppm.

In an embodiment, the method of treating a hydrocarbon fluid provides for adding an encapsulated production chemical to the hydrocarbon fluid prior to the hydrocarbon fluid being extracted from the well and/or after the hydrocarbon fluid has been extracted from the well, or a combination thereof. In an embodiment, the well is located underwater. In an embodiment, the well is a deep water well located at least 1000 meters below the surface of the water.

In an embodiment, the encapsulated production chemical is added to a subterranean well. In an embodiment, the encapsulated production chemical may be added to a hydrocarbon fluid in the well (i.e. a first hydrocarbon fluid. In an embodiment, a hydrocarbon fluid containing the encapsulated production chemical (i.e. a second hydrocarbon fluid) may be produced from the well. In another embodiment, the encapsulated production chemical may be added to a hydrocarbon fluid produced from a well at the well head or at the surface. In still another embodiment, the encapsulated production chemical is added to a hydrocarbon fluid prior to transporting the hydrocarbon fluid in a pipeline or a tank.

Although the preceding description has been described herein with reference with particular means, materials, and embodiments, it is not intended to be limited to the particulars disclosed herein; rather, it extends to all functionally equivalent structures, methods, and uses, such as are within the scope of the appended claims.

What is claimed is:

1. A composition comprising:
a branched polymer encapsulating a guest molecule to be released under oilfield conditions.

2. The composition of claim 1, wherein the guest molecule comprises a production chemical.

3. The composition of claim 2, wherein the production chemical comprises an asphaltene dispersant, a pour point depressant, a biocide, a wax inhibitor, a scale inhibitor, a corrosion inhibitor, a demulsifier, a hydrogen sulfide scavenger, a defoamer, a gas hydrate inhibitor, or a combination thereof.

4. The composition of claim 1, wherein the branched polymer also serves as a production chemical.

5. The composition of claim 4, wherein the branched polymer serves an asphaltene dispersant, a pour point depressant, a biocide, a wax inhibitor, a scale inhibitor, a corrosion inhibitor, a demulsifier, a hydrogen sulfide scavenger, a defoamer, a gas hydrate inhibitor, or a combination thereof.

6. The composition of claim 1, wherein the branched polymer comprises a dendrimer, a polyester polyol, a polyethylenimine, or a combination thereof.

7. A method comprising:
encapsulating at least one production chemical within a branched polymer.

8. The method of claim 7, wherein the production chemical comprises an asphaltene dispersant, a pour point depressant, a biocide, a wax inhibitor, a scale inhibitor, a corrosion inhibitor, a demulsifier, a hydrogen sulfide scavenger, a defoamer, a gas hydrate inhibitor, or a combination thereof.

9. The method of claim 7, wherein the branched polymer comprises a dendrimer, a polyester polyol, a polyethylenimine, or a combination thereof.

10. The method of claim 7, wherein the branched polymer also serves as a production chemical.

11. The method of claim 10, wherein the production chemical comprises an asphaltene dispersant, a pour point depressant, a biocide, a wax inhibitor, a scale inhibitor, a corrosion inhibitor, a demulsifier, a hydrogen sulfide scavenger, a defoamer, a gas hydrate inhibitor, or a combination thereof.

12. The method of claim 10 further comprising adding said encapsulated production chemical into a hydrocarbon fluid.

13. The method of claim 12 wherein the encapsulated production chemical is present in the hydrocarbon fluid at a concentration between 10-1000 ppm.

14. The method of claim 10 wherein the hydrocarbon fluid is a hydrocarbon fluid produced during extraction of hydrocarbons from a well, crude oil, a crude oil condensate, a middle distillate, a fuel oil, diesel, or a combination thereof.

15. The method of claim 10 wherein the encapsulated production chemical is added to the hydrocarbon fluid prior to the hydrocarbon fluid being extracted from a well.

16. The method of claim 10 wherein the encapsulated production chemical is added to the hydrocarbon fluid prior to transporting the hydrocarbon fluid in a pipeline.

17. A method comprising:
treating a hydrocarbon fluid with a production chemical encapsulated within a branched polymer.

18. The method of claim 17 wherein the production chemical comprises an asphaltene dispersant, a pour point depressant, a biocide, a wax inhibitor, a scale inhibitor, a corrosion inhibitor, a demulsifier, a hydrogen sulfide scavenger, a defoamer, a gas hydrate inhibitor, or a combination thereof.

19. The method of claim 17 wherein the hydrocarbon fluid is a hydrocarbon fluid produced during extraction of hydrocarbons from a well, crude oil, a crude oil condensate, a middle distillate, a fuel oil, diesel, or a combination thereof.

20. The method of claim 17 wherein treatment of the hydrocarbon fluid occurs prior to the hydrocarbon fluid being extracted from a well.
